(19) United States
(12) Patent Application Publication
(10) Pub. No.: US 2013/0230622 A1
(43) Pub. Date: Sep. 5, 2013

(54) LAMINATED FLAVORED PASTRY AND METHOD OF MANUFACTURING THEREOF

(71) Applicants: Kathleen Robbins, Cutchogue, NY (US); Weizhu Yu, Morris Plains, NJ (US)

(72) Inventors: Kathleen Robbins, Cutchogue, NY (US); Weizhu Yu, Morris Plains, NJ (US)

(73) Assignee: Grupo Bimbo, S.A.B. de C.V., Mexico City (MX)

(21) Appl. No.: 13/863,933

(22) Filed: Apr. 16, 2013

Related U.S. Application Data
(63) Continuation-in-part of application No. 13/117,025, filed on May 26, 2011.

(51) Int. Cl. A21D 13/00; A21D 8/04

(52) U.S. Cl. CPC A21D 13/0061; A21D 8/045; A21D 13/0064
USPC 426/19; 426/61; 426/62

(57) ABSTRACT

A method of manufacturing an edible product, a laminated dough composition and an edible product are provided. The method includes mixing ingredients including starch, gluten, a plasticizer, fat and leavening into a pastry dough composition. A flavored fat composition is prepared by mixing ingredients comprising fat, at least one flavor additive and at least one filling. The flavored fat composition is then applied to a surface of the pastry dough composition. Both compositions are folded and sheeted to form a laminated dough. The laminated dough is then formed into pieces, which are proofed and then baked. A laminated dough composition, and an edible product itself, is provided that comprises a plurality of layers of a flavored fat interposed between a plurality of layers of a pastry dough, the pastry dough composition comprising starch, gluten, a plasticizer, fat and leavening; the flavored fat composition comprising fat, at least one flavor additive and at least one filling.

### PRIORITY

This patent document is a continuation-in-part (CIP) of U.S. application Ser. No. 13/117,025 filed on May 26, 2011 which is hereby incorporated by reference in its entirety.

### FIELD

The present disclosure relates to baked goods, in particular, laminated dough products such as pastries or croissants, and methods of making the same.

### BACKGROUND

The statements in this section merely provide background information related to the present disclosure and may not constitute prior art.

Croissants are specialized baked goods, wherein multiple layers are present with air pockets, or voids, in between the layers to produce a light, flaky and unique pastry. Generally, to form a croissant, a laminated dough is formed by folding and rolling alternating layers of dough and fat. The presence of a fat layer between dough layers produces a flaky consistency after baking. For example, in puff pastries made from unleavened laminated dough, the dough layers expand and cook individually when steam is formed during baking. In laminated dough products incorporating a leavening agent, such as croissants, the gases released by the leavening agent during proofing expand the layers and produce the flaky consistency. Methods of creating different variants of laminated dough products are continually being developed in order to differentiate baked goods on the market.

### SUMMARY

In one form of the present disclosure, a method of manufacturing an edible product is provided that comprises mixing ingredients including starch, gluten, a plasticizer, fat and leavening into a pastry dough composition. A flavored fat composition is prepared by mixing ingredients comprising fat and at least one flavor additive to create a flavored fat composition. The flavored fat composition is then applied to a surface of the pastry dough composition. Both compositions are folded and sheeted to form a laminated dough. The laminated dough is then formed into pieces, which are proofed and then baked.

In another form of the present disclosure, a laminated dough composition is provided that comprises a plurality of layers of a flavored fat interposed between a plurality of layers of a pastry dough composition. The pastry dough has a composition comprising starch, gluten, a plasticizer, fat, and leavening. The flavored fat has a composition comprising fat and at least one flavor additive.

In still another form, a laminated dough composition is provided that comprises a plurality of layers of a flavored fat interposed between a plurality of layers of a pastry dough. The pastry dough has a composition comprising wheat flour, water, a sweetener, fat, salt, at least one emulsifier, at least one preservative, yeast, at least one enzyme, and a derivative of milk. The flavored fat has a composition comprising fat, a sweetener, at least one color additive, at least one flavor additive, and at least one filling. The filling is selected from the group consisting of spices, seasonings, cocoa, chocolate, cheese, cream cheese, herbs, garlic, and fruit.

In yet another form of the present disclosure, an edible product is provided that comprises a plurality of layers of a flavored fat interposed between a plurality of layers of a pastry dough. The pastry dough has a composition comprising starch, gluten, a plasticizer, fat, and leavening. The flavored fat has a composition comprising fat and at least one flavor additive.

In another form, an edible product is provided that comprises a plurality of layers of a flavored fat interposed between a plurality of layers of a pastry dough. The pastry dough has a composition comprising starch, gluten, a plasticizer, fat, and leavening. The flavored fat has a composition comprising fat and at least one flavor additive. The edible product is configured to fit into a conventional toaster.

In still another form, an edible product is provided that comprises a plurality of layers of a flavored fat interposed between a plurality of layers of a pastry dough. The pastry dough has a composition comprising wheat flour, water, a sweetener, fat, salt, at least one emulsifier, at least one preservative, yeast, at least one enzyme, and a derivative of milk. The flavored fat has a composition comprising fat, a sweetener, at least one color additive, at least one flavor additive, and at least one filling. The filling is selected from the group consisting of spices, seasonings, cocoa, chocolate, cream cheese, herbs, garlic, and fruit. The edible product is configured to fit into a conventional toaster.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a flow diagram of a method of manufacturing an edible product in accordance with the teachings of the present disclosure; and

FIG. 2 is a perspective view of an edible product manufactured in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

The present disclosure provides a unique and tasteful laminated dough product that incorporates flavor into the dough layers, and which can be further shaped to fit into a conventional toaster. In accordance with the teachings of the present disclosure, a laminated dough is formed wherein the fat layer incorporates at least one flavor additive. In other words, flavor is integrated into the dough during the lamination process (sheeting and folding), rather than applied after the lamination, such that the flavor is built into the plurality of dough layers forming the laminated dough product. In addition to its unique flavor, such a flavored laminated dough product or pastry is more suitable to be inserted into a toaster, and has not before been seen or produced. Since the flavoring is embedded within the dough layers rather than being applied as a coating or topping, the flavor remains integrated within the pastry and provides a unique and robust flavor. Furthermore, such a method of integrating flavor into the dough layers avoids spillage or problems that could arise when a pastry flavored with a traditional topping or filling is inserted into a toaster.

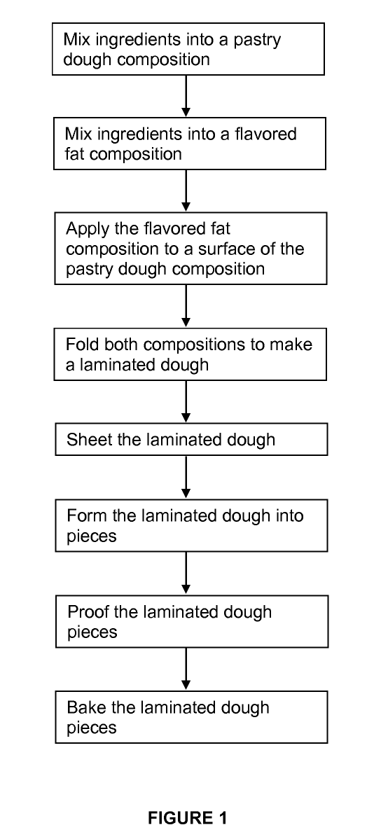

FIG. 1 is a flow diagram of a method of manufacturing an edible product in accordance with the teachings of the present invention. According to a method of the present disclosure, ingredients are mixed to form a pastry dough composition. The ingredients may include, but are not limited to, starch, gluten, a plasticizer, fat and leavening. The starch can be potato, rice, corn, wheat or tapioca starch. Alternatively, the starch and gluten can be substituted by any grain flour, such as wheat flour or buckwheat flour, among others. The plasticizer can be water, milk or glycerol. The fat may be, by way of example, butter, margarine, and shortening. The leavening can be yeast or a chemical leavening. It should be understood that these exemplary ingredients have been successfully combined to produce uniquely flavored edible products and that other ingredients not specifically described herein may also be incorporated while remaining within the scope of the present disclosure. As long as the ingredients produce a layered pastry dough composition having a flavored fat composition integrated therein, such ingredients shall be construed as falling within the scope of the present disclosure.

In one exemplary form of the present disclosure, the pastry dough composition may further comprise salt. In another form, the pastry dough composition may further comprise at least one preservative, such as Potassium sorbate, sorbic acid or Calcium propionate, for example. In yet another form, the pastry dough composition may further include at least one enzyme, such as, for example, amylase. In another form, the pastry dough composition may further comprise at least one emulsifier. Examples of emulsifiers include mono, distilled and succinctilated mono, diglycerides, Sodium Stearoyl Lactylate (SSL), sugar esters, and Diacetyl Tartaric Acid Ester of monoglyceride (DATEM). In another form of the present disclosure, the pastry dough composition may further include a derivative of milk such as nonfat dry milk, whole milk powder, or whey. In yet another form, the pastry dough composition may further include a sweetener. The sweetener may be, by way of example, sugar, liquid sucrose, high-fructose corn syrup, dextrose, maple syrup, honey and corn syrup.

The pastry dough composition, in one form, is shown below in Table 1. This composition is merely exemplary and should not be construed as limiting the scope of the present disclosure.

TABLE 1

| | Weight, based on 100 pounds of flour |
|---|---|
| Ingredient | (baker's percentage) |
| Wheat Flour | 100 |
| Water | 45-65 |
| Sweetener | 2-20 |
| Fat | 5-25 |
| Salt | <4 |
| Emulsifier | <2 |
| Preservative | <2 |
| Yeast | <10 |
| Enzyme | <2 |
| Derivative of Milk | <5 |

A target weight, based on 100 pounds of flour (or baker's percent), is provided for each ingredient in an exemplary composition in Table 2.

TABLE 2

| | Target Weight, based on 100 pounds |
|---|---|
| Ingredient | of flour (baker's percentage) |
| Wheat Flour | 100 |
| Water | 55 |
| Sweetener | 11.75 |
| Fat | 22 |
| Salt | 1 |
| Emulsifier | 0.725 |
| Preservative | 0.875 |
| Yeast | 5 |
| Enzyme | 0.5 |
| Derivative of Milk | 1.25 |

It should be understood that the target weight values provided in the preceding table pertain to an exemplary composition (i.e. recipe), and such values will vary depending on the type of ingredients and substitute ingredients used.

After the ingredients comprising the pastry dough composition are mixed, a flavored fat composition is formed by mixing fat and at least one flavor additive. The fat may include, by way of example, butter, margarine, and shortening. The flavor additive can be a natural or artificial flavor. In one exemplary form of the present disclosure, the flavored fat composition may further comprise a sweetener such as, by way of example, sugar, liquid sucrose, high-fructose corn syrup, dextrose, maple syrup, honey and corn syrup. In another form, the flavored fat may further comprise at least one color additive. The color additive may be a natural or artificial color. In yet another form, the flavored fat composition may further comprise a filling. Exemplary fillings include spices, seasonings, cocoa, chocolate, cheese, cream cheese, herbs, garlic, and fruit. Exemplary spices include cinnamon, mustard and cloves. Exemplary herbs include oregano and rosemary. One advantage of incorporating a filling into the fat layer as opposed to the dough layer is preventing certain fillings (e.g. spices such as cinnamon) from killing the yeast activity in the dough.

The flavored fat composition, in one form, is shown below in Table 3. This composition is merely exemplary and should not be construed as limiting the scope of the present disclosure.

TABLE 3

| Ingredient | Weight based upon true percentage |
|---|---|
| Fat | 45-75 |
| Sweetener | 0-50 |
| Filling | 0-50 |
| Flavor Additive | <2 |
| Color Additive | <2 |

A target weight, based upon true percentage, is provided for each ingredient in an exemplary composition in Table 4.

TABLE 4

| | Target Weight, based on true |
|---|---|
| Ingredient | percentage |
| Fat | 54 |
| Sweetener | 36 |
| Filling | 7 |
| Flavor Additive | 1.5 |
| Color Additive | 1.5 |

It should be understood that the target weight values provided in the preceding table pertain to an exemplary composition (i.e. recipe), and such values will vary depending on the type of ingredients and substitute ingredients used.

The flavored fat composition is applied to a surface of the pastry dough composition. The flavored fat composition may be extruded onto the pastry dough composition, or applied using other methods that may include commercial equipment. Then, both compositions are folded to make a laminated dough, which is further sheeted. It should be understood that the folding and sheeting may be repeated more than once depending on the desired number of alternating layers of dough and fat. In one form of the present disclosure, the laminated dough is formed into a final sheet having a thickness between about 2 mm (0.08 in) and about 20 mm (0.8 in).

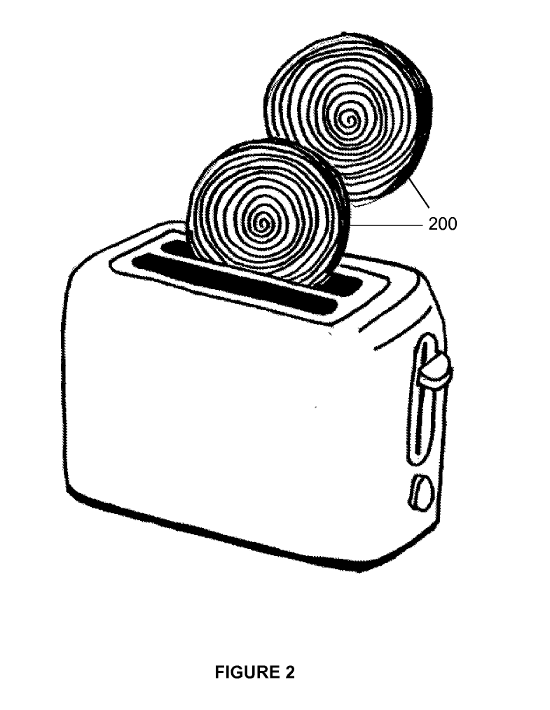

After sheeting the laminated dough, it is formed into pieces. The pieces may be formed by cutting or stamping, for example. The pieces may be circular or quadrangular, among other shapes. It should be understood that any shape may be employed while remaining within the scope of the present disclosure. In one exemplary form of the present disclosure, the laminated dough is coiled prior to forming it into pieces. A “swirl” may be visually perceptible in the final coiled product as a result of any filling present in the fat layers, as illustrated in FIG. 2. In another form, a filling layer may be applied to the laminated dough pieces prior to coiling. Therefore, after forming, the product further comprises a filling layer in addition to the pastry dough and flavored fat layers, which further enhances the flavor imparted by the flavored fat layers and enhances the visually perceptible “swirl” in the final coiled product as illustrated in FIG. 2. The filling in the filling layer may include spices, seasonings, cocoa, chocolate, cheese, cream cheese, herbs, garlic, or fruit. Exemplary spices include cinnamon, mustard and cloves. Exemplary herbs include oregano and rosemary.

The laminated dough pieces are then proofed prior to baking. In one form, the laminated dough pieces are proofed between approximately forty-five (45) minutes and approximately three (3) hours, at between approximately seventy-five (75) degrees Fahrenheit (approximately twenty-three (23) degrees Celsius) and approximately one-hundred-ten (110) degrees Fahrenheit (approximately forty-three (43) degrees Celsius), and at between approximately sixty-five (65) and approximately one-hundred (100) percent relative humidity.

Finally, the laminated dough pieces are baked, and in one form, between approximately ten (10) and approximately fifteen (15) minutes at between approximately three-hundred-thirty (330) degrees Fahrenheit (approximately one-hundred-five (165) degrees Celsius) and approximately four-hundred-twenty (420) degrees Fahrenheit (approximately two-hundred-fifteen (215) degrees Celsius).

In one exemplary form of the present disclosure, a coating is applied to the surface of the laminated dough pieces prior to baking or after baking. The coating may be egg wash, or a substitute egg wash composition.

In another exemplary form of the present disclosure, the laminated dough pieces are shaped to fit into a conventional toaster after baking. This form of the present disclosure may be better understood with reference to FIG. 2. The laminated dough pieces 200 may be rolled, for example, to achieve a desired thickness. In one example, the outer periphery of the pieces shaped to fit a toaster have a maximum outer diameter, or peripheral dimension, between approximately three (3) and approximately four (4) inches, and a maximum thickness between about 21.6 mm (0.85 in) and about 29.2 mm (1.15 in).

It should be noted that the disclosure is not limited to the various forms described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A method of manufacturing an edible product, the method comprising:
mixing ingredients comprising starch, gluten, a plasticizer, fat and leavening into a pastry dough composition;
mixing ingredients comprising fat, at least one flavor additive and at least one filling into a flavored fat composition;
applying the flavored fat composition to a surface of the pastry dough composition;
folding both compositions to make a laminated dough;
sheeting the laminated dough;
forming the laminated dough into pieces;
proofing the laminated dough pieces; and
baking the laminated dough pieces;
wherein the filling is selected from the group consisting of spices, seasonings, cocoa, chocolate, cheese, cream cheese, herbs, garlic, and fruit.

2. The method of claim 1, further comprising the step of:
coiling the laminated dough prior to forming it into pieces.

3. The method of claim 2, further comprising the step of:
applying a filling layer to the laminated dough prior to coiling.
wherein the filling is selected from the group consisting of spices, seasonings, cocoa, chocolate, cheese, cream cheese, herbs, garlic, and fruit.

4. The method of claim 1, wherein the filling is cocoa.

5. The method of claim 1, wherein the filling is cheese.

6. The method of claim 1, wherein the filling is fruit.

7. The method of claim 1, wherein the proofing is between approximately 45 minutes and approximately 3 hours at between approximately 75 and approximately 110 degrees Fahrenheit, and at between approximately 65% and approximately 100% relative humidity.

8. The method of claim 1, wherein the baking is between approximately 10 and approximately 15 minutes at between approximately 330 and approximately 420 degrees Fahrenheit.

9. A laminated dough composition comprising:
a plurality of layers of a flavored fat interposed between a plurality of layers of a pastry dough,
the pastry dough having a composition comprising starch, gluten, a plasticizer, fat, and leavening; and
the flavored fat having a composition comprising fat, at least one flavor additive and at least one filling,
wherein the filling is selected from the group consisting of spices, seasonings, cocoa, chocolate, cheese, cream cheese, herbs, garlic, and fruit.

10. The laminated dough composition of claim 9, wherein the filling is cinnamon.

11. The laminated dough composition of claim 9, wherein the filling is mustard.

12. The laminated dough composition of claim 9, wherein the filling is clove.

13. The laminated dough composition of claim 9, wherein the filling is oregano.

14. The laminated dough composition of claim 9, wherein the filling is rosemary.

15. The laminated dough composition of claim 9, wherein the filling is cocoa.

16. The laminated dough composition of claim 9, wherein the filling is cheese.

17. The laminated dough composition of claim 9, wherein the filling is garlic.

18. The laminated dough composition of claim 9, wherein the flavored fat composition further comprises:
a sweetener selected from the group consisting of sugar, liquid sucrose, high-fructose corn syrup, dextrose, maple syrup, honey and corn syrup.

19. The laminated dough composition of claim 9, wherein the filling is fruit.

20. The laminated dough composition of claim 9, wherein the pastry dough composition comprises the following ingredients expressed in baker's percentage:
about 100% wheat flour;
from about 45% to about 65% water;
from about 2% to about 20% sweetener;
from about 5% to about 25% fat;
less than about 4% of salt;
less than about 10% of yeast;
less than about 5% of a derivative of milk; and
less than about 2% of at least one emulsifier, at least one preservative, and at least one enzyme. ttorney Docket No. 14254-81

21. The laminated dough composition of claim 18, wherein the flavored fat composition comprises:
from about 45% to about 75% fat;
from about 0% to about 50% sweetener;
from about 0% to about 50% filling; and
less than about 2% of at least one color additive and at least one flavor additive.

22. An edible product comprising:
a plurality of layers of a flavored fat interposed between a plurality of layers of a pastry dough,
the pastry dough having a composition comprising starch, gluten, a plasticizer, fat and leavening; and
the flavored fat having a composition comprising fat, at least one flavor additive and at least one filling;
wherein the filling is selected from the group consisting of spices, seasonings, cocoa, chocolate, cheese, cream cheese, herbs, garlic, and fruit; and
wherein the edible product defines an outer periphery having a maximum outer dimension between approximately 3 and 4 inches, and a maximum thickness of between approximately 0.85 and about 1.15 inches.
